(19) United States
(12) Patent Application Publication
(10) Pub. No.: US 2016/0062104 A1
(43) Pub. Date: Mar. 3, 2016

(54) EYEPIECE LENS, OBSERVATION DEVICE INCLUDING THE SAME, AND IMAGING APPARATUS

(71) Applicant: CANON KABUSHIKI KAISHA, Tokyo (JP)

(72) Inventors: Tomonori Kimura, Utsunomiya-shi (JP); Hirofumi Abe, Utsunomiya-shi (JP)

(21) Appl. No.: 14/832,926

(22) Filed: Aug. 21, 2015

(30) Foreign Application Priority Data
Aug. 29, 2014 (JP) 2014-176292
Aug. 29, 2014 (JP) 2014-176296

(51) Int. Cl. G02B 25/00

(52) U.S. Cl. CPC G02B 25/001

(57) ABSTRACT

One or more eyepiece lenses, one or more observation devices using an eyepiece lens and one or more imaging apparatuses using an eyepiece lens are provided herein. At least one embodiment of an eyepiece lens includes five or more lenses, including two or more resin lenses each having a lens surface of an aspheric shape, in which a glass lens is arranged closest to an observation side in the eyepiece lens, and a specific gravity of a material of all of the two or more resin lenses is appropriately set.

### BACKGROUND OF THE INVENTION

1. Field of the Invention

The present disclosure relates to an eyepiece lens, an observation device including the same, and an imaging apparatus, which are suitable to observe an image displayed on an image display device in an electronic viewfinder used in an optical device or a camera, such as, a video camera, a still camera, or a broadcasting camera, for example.

2. Description of the Related Art

Conventionally, an electronic viewfinder used in an optical apparatus such as a video camera or a broadcasting camera is provided with an eyepiece lens for enlarging and observing an image displayed on a liquid crystal screen provided inside the camera.

In recent years, an optical apparatus such as a video camera or a broadcasting camera, which has high optical performance and has realized weight reduction, are required. Accordingly, the viewfinder and an eyepiece lens that constitutes the viewfinder provided in the video camera or the broadcasting camera are required to be light and have a high definition observation image.

Japanese Patent Application Laid-Open No. 2013-45020 discusses an eyepiece lens that corrects various aberrations and improves optical performance by an increase in the number of lenses that constitutes the eyepiece lens. Typically, the optical performance of an eyepiece lens is improved by an increase in the number of lenses that constitutes the eyepiece lens. However, on the other hand, it is difficult to realize weight reduction.

### SUMMARY OF THE INVENTION

According to an aspect of the present disclosure, at least one embodiment of an eyepiece lens includes five or more lenses, including two or more resin lenses each having a lens surface of an aspheric shape, wherein material of a lens Le arranged closest to an observation side of the eyepiece lens is glass material, and material of all of the two or more resin lenses included in the eyepiece lens satisfies a following conditional expression: 0.5<Rdens<1.5, where a specific gravity of the material of all of the two or more resin lenses is Rdens.

According to a further aspect of the present disclosure, at least one embodiment of an eyepiece lens includes five or more lenses, wherein a following conditional expression is satisfied: 5.0<νd<30.0, where an Abbe number of material of the five or more lenses for a d line is νd, a resin lens R having a lens surface of an aspheric shape is included in the five or more lenses, and lenses using glass material are respectively arranged at an object side and at an observation side of the resin lens R.

According to other aspects of the present disclosure, one or more additional eyepiece lenses, one or more observation devices including the same, and one or more imaging apparatuses are discussed herein. Further features of the present disclosure will become apparent from the following description of exemplary embodiments with reference to the attached drawings.

### BRIEF DESCRIPTION OF THE DRAWINGS

FIG. 1 is a lens cross-sectional view of an eyepiece lens according to a first exemplary embodiment of the present disclosure.

FIG. 2 illustrates aberration diagrams of the eyepiece lens according to the first exemplary embodiment of the present disclosure.

FIG. 3 is a lens cross-sectional view of an eyepiece lens according to a second exemplary embodiment of the present disclosure.

FIG. 4 illustrates aberration diagrams of the eyepiece lens according to the second exemplary embodiment of the present disclosure.

FIG. 5 is a lens cross-sectional view of an eyepiece lens according to a third exemplary embodiment of the present disclosure.

FIG. 6 illustrates aberration diagrams of the eyepiece lens according to the third exemplary embodiment of the present disclosure.

FIG. 7 is a lens cross-sectional view of an eyepiece lens according to a fourth exemplary embodiment of the present disclosure.

FIG. 8 illustrates aberration diagrams of the eyepiece lens according to the fourth exemplary embodiment of the present disclosure.

FIG. 9 is a lens cross-sectional view of an eyepiece lens according to a fifth exemplary embodiment of the present disclosure.

FIG. 10 illustrates aberration diagrams of the eyepiece lens according to the fifth exemplary embodiment of the present disclosure.

FIG. 11 is a lens cross-sectional view of an eyepiece lens according to a sixth exemplary embodiment of the present disclosure.

FIG. 12 illustrates aberration diagrams of the eyepiece lens of the sixth exemplary embodiment of the present disclosure.

FIG. 13 is a lens cross-sectional view of an eyepiece lens according to a seventh exemplary embodiment of the present disclosure.

FIG. 14 illustrates aberration diagrams of the eyepiece lens according to the seventh exemplary embodiment of the present disclosure.

FIG. 15 is a schematic diagram of principal parts of an imaging apparatus according to an exemplary embodiment of the present disclosure.

### DESCRIPTION OF THE EMBODIMENTS

Hereinafter, an eyepiece lens, an observation device including the same, and an imaging apparatus according to exemplary embodiments of the present disclosure will be described in detail based on the appended drawings.

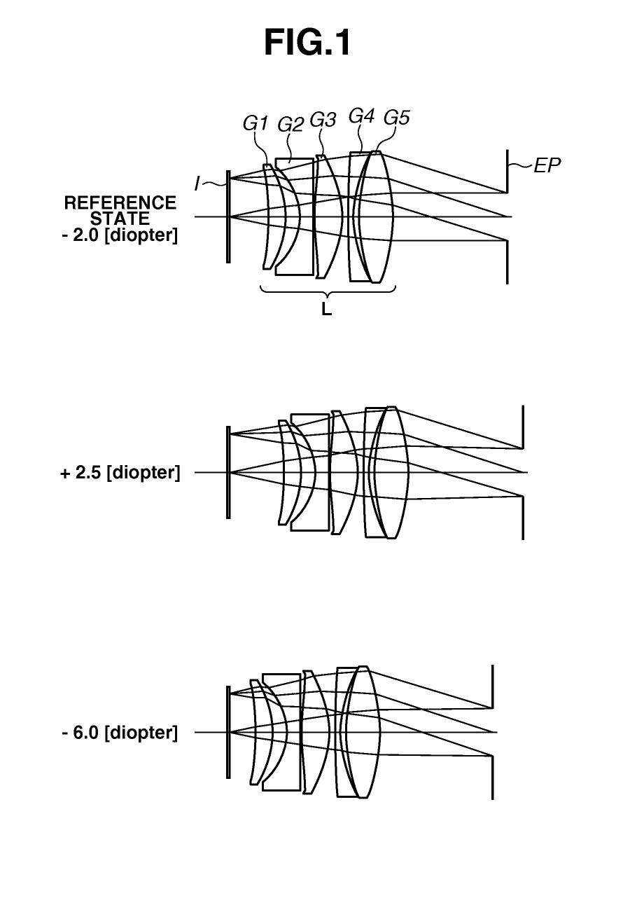

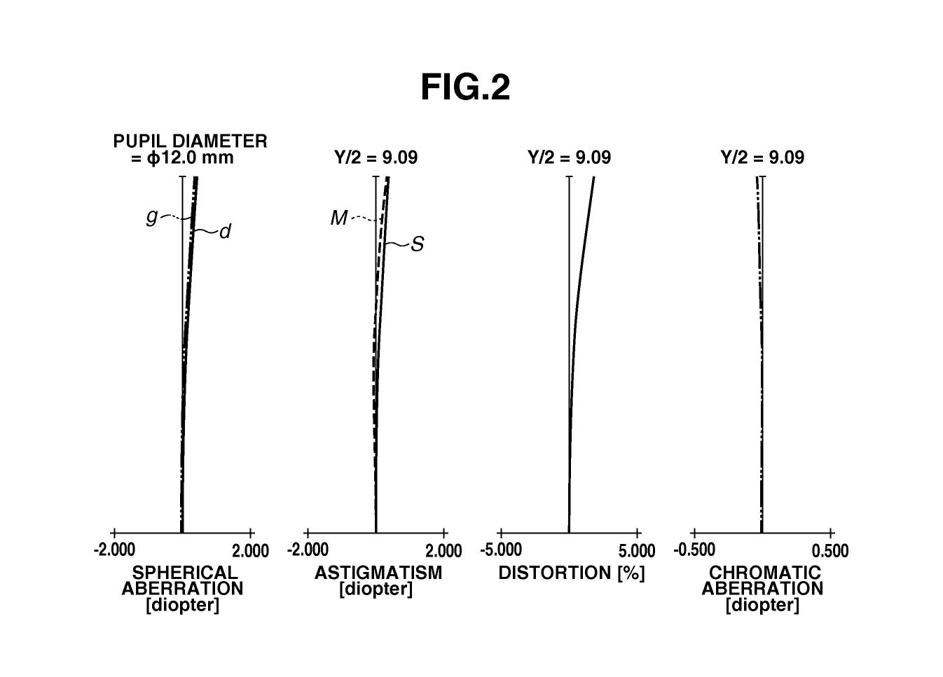

FIG. 1 is a lens cross-sectional view of a case where the diopter of an eyepiece lens according to a first exemplary embodiment is −2.0 diopter (reference state), 2.5 diopter, and −6.0 diopter. FIG. 2 is aberration diagrams in the reference state of the eyepiece lens of the first exemplary embodiment.

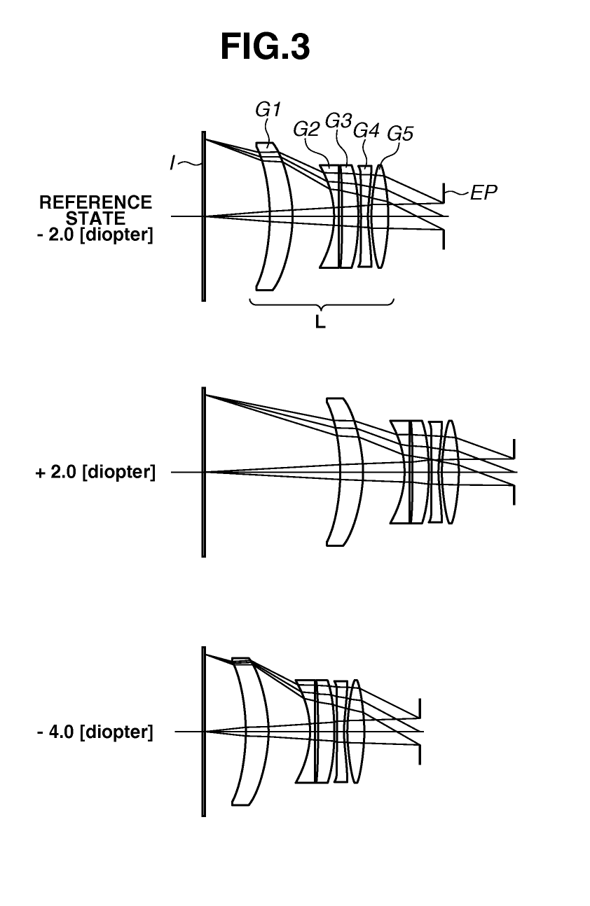

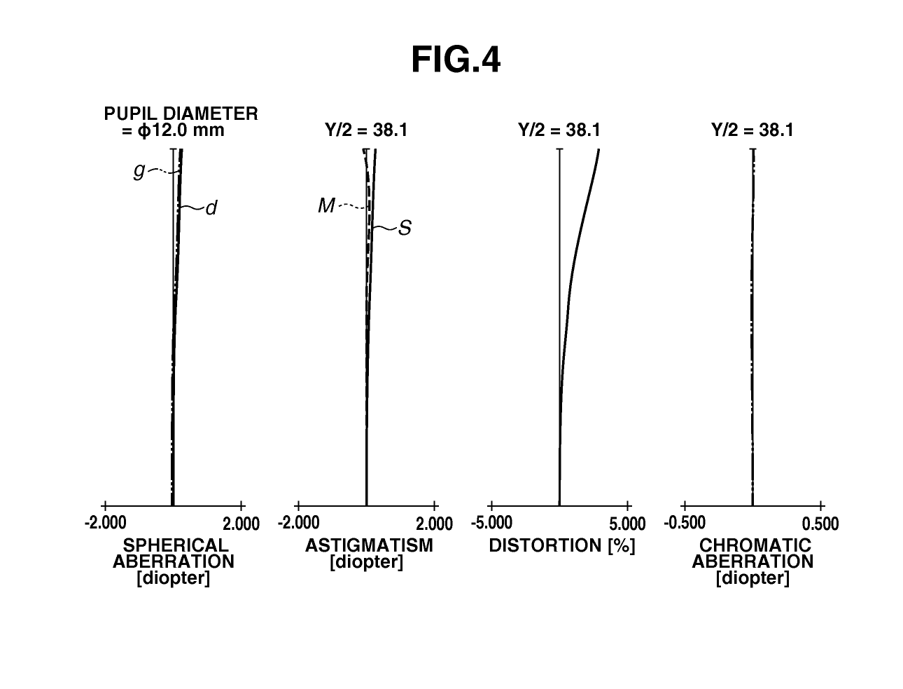

FIG. 3 is a lens cross-sectional view of a case where the diopter of an eyepiece lens of a second exemplary embodiment is −2.0 diopter (reference state), 2.0 diopter, and −4.0 diopter. FIG. 4 is aberration diagrams in the reference state of the eyepiece lens of the second exemplary embodiment.

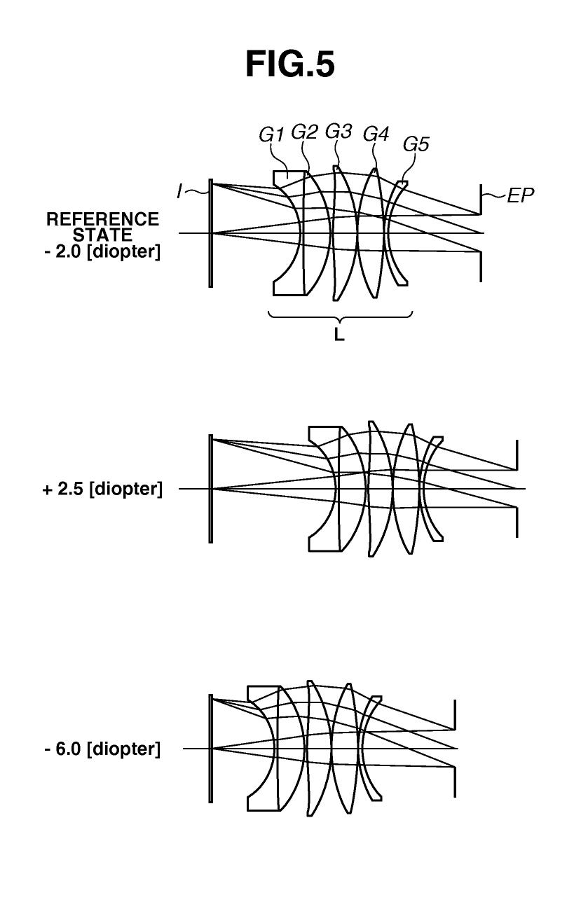

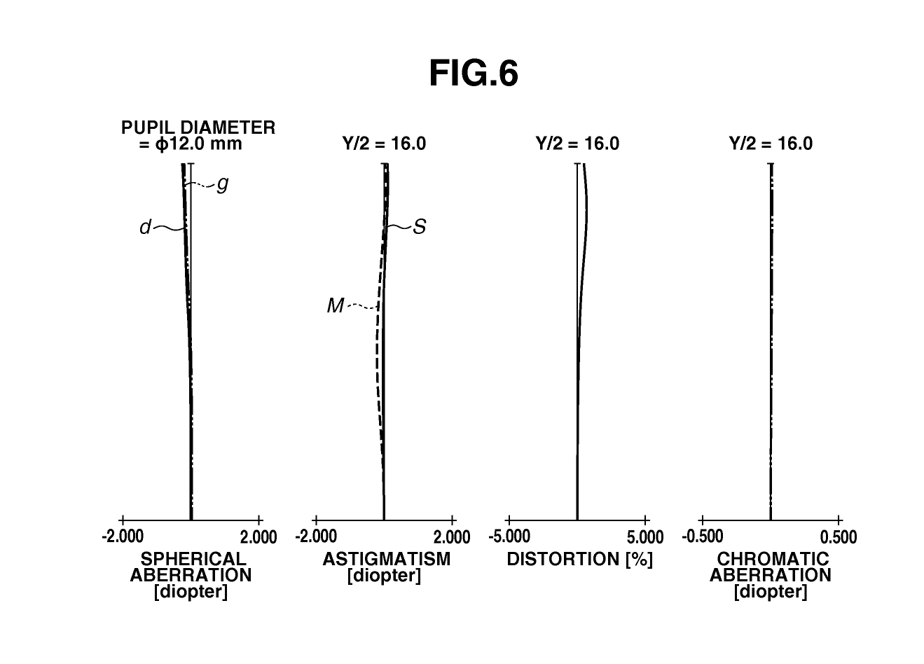

FIG. 5 is a lens cross-sectional view of a case where the diopter of an eyepiece lens of a third exemplary embodiment is −2.0 diopter (reference state), 2.5 diopter, and −6.0 diopter. FIG. 6 is aberration diagrams in the reference state of the eyepiece lens of the third exemplary embodiment.

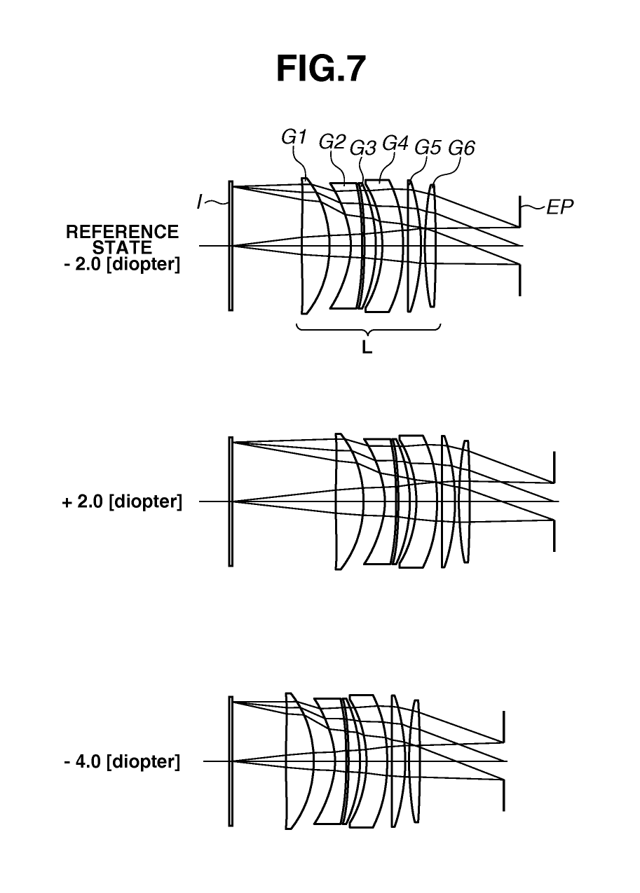

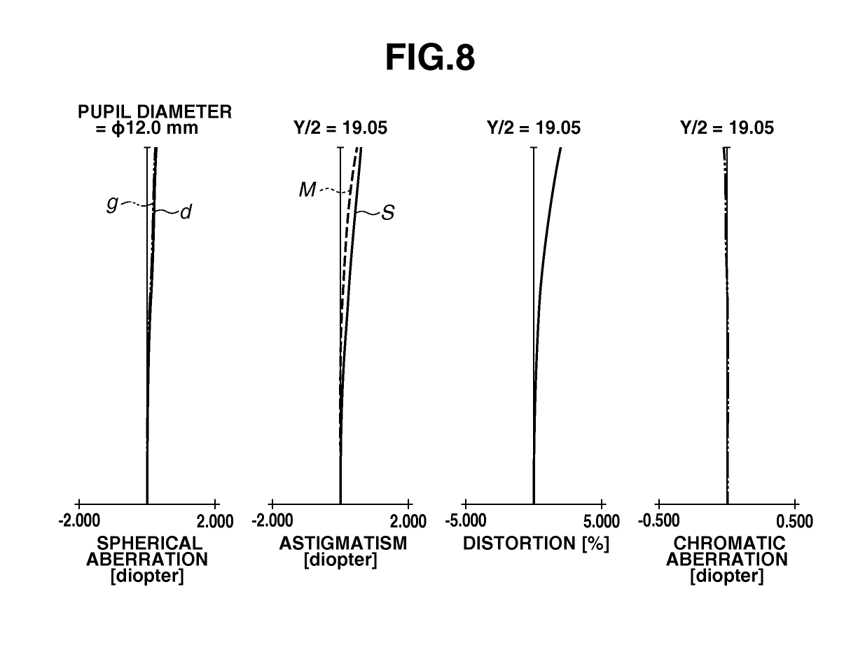

FIG. 7 is a lens cross-sectional view of a case where the diopter of an eyepiece lens of a fourth exemplary embodiment is −2.0 diopter (reference state), 2.0 diopter, and −4.0 diopter. FIG. 8 is aberration diagrams in the reference state of the eyepiece lens of the fourth exemplary embodiment.

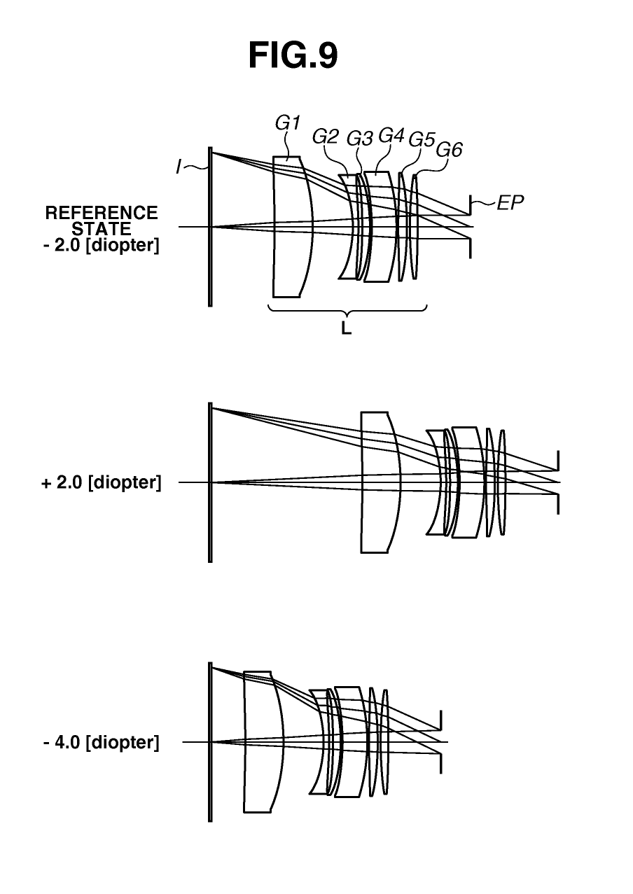

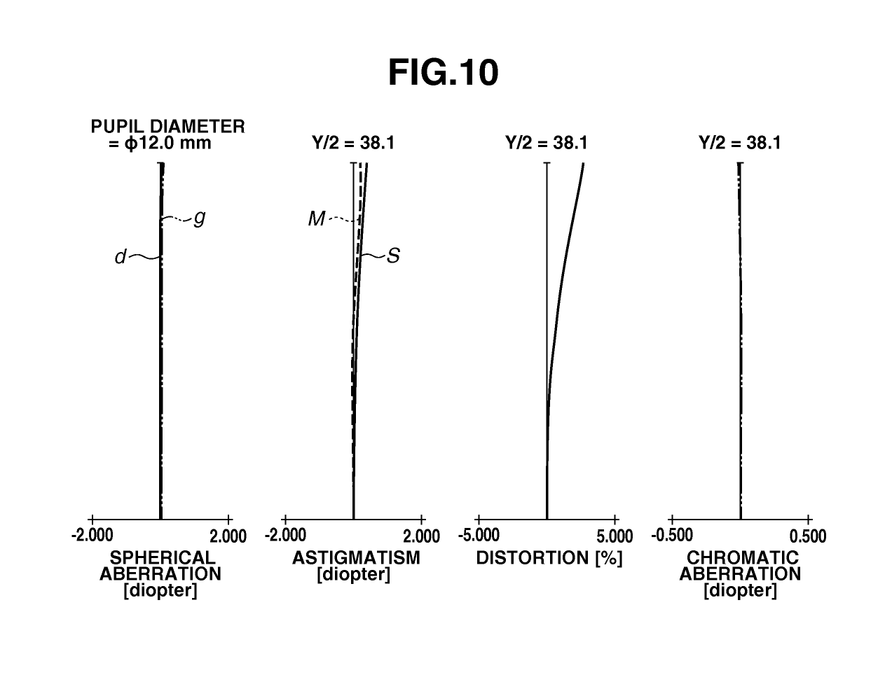

FIG. 9 is a lens cross-sectional view of a case where the diopter of an eyepiece lens of a fifth exemplary embodiment is −2.0 diopter (reference state), 2.0 diopter, and −4.0 diopter. FIG. 10 is aberration diagrams in the reference state of the eyepiece lens of the fifth exemplary embodiment.

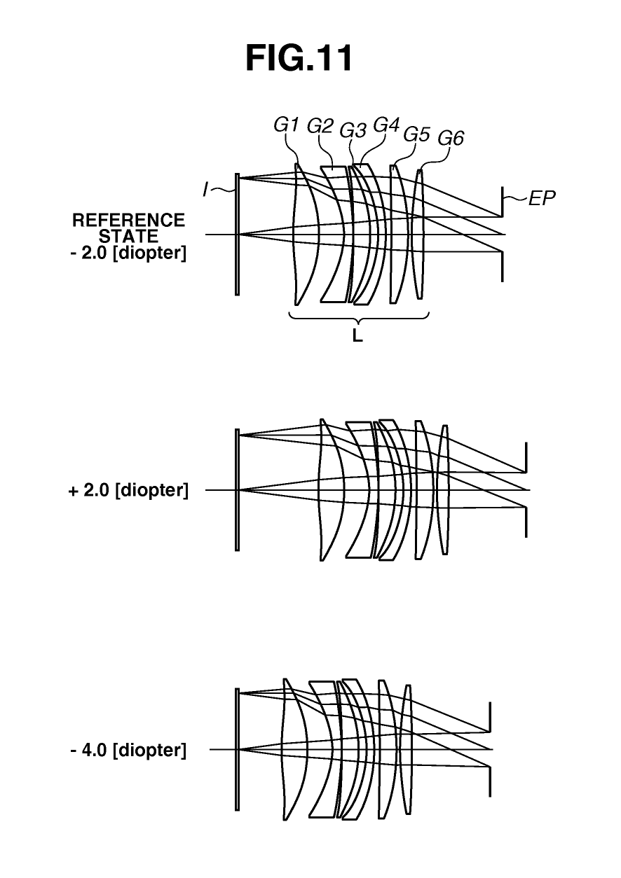

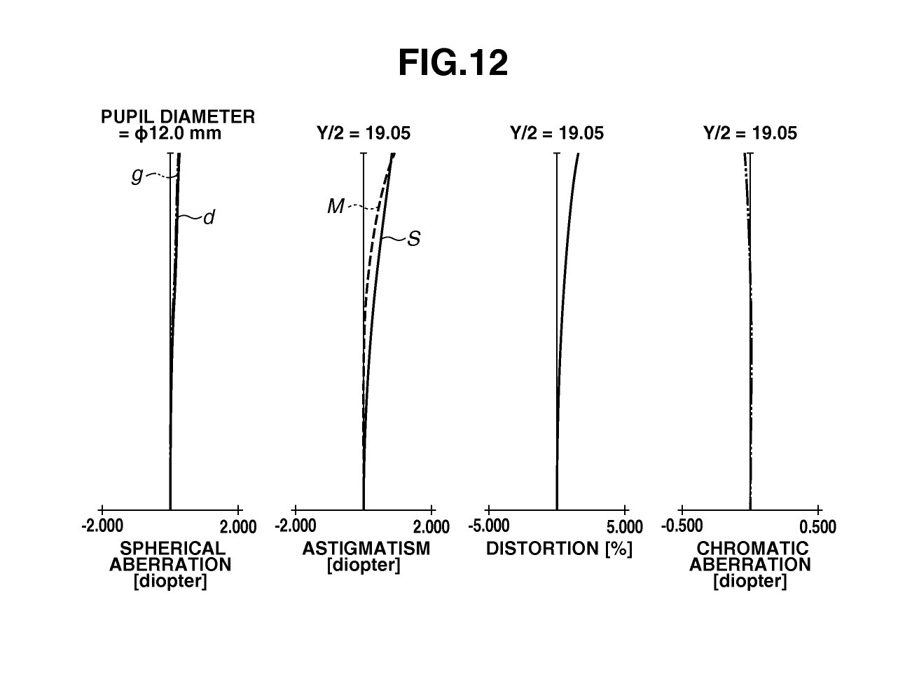

FIG. 11 is a lens cross-sectional view of a case where the diopter of an eyepiece lens of a sixth exemplary embodiment is −2.0 diopter (reference state), 2.0 diopter, and −4.0 diopter. FIG. 12 is aberration diagrams in the reference state of the eyepiece lens of the sixth exemplary embodiment.

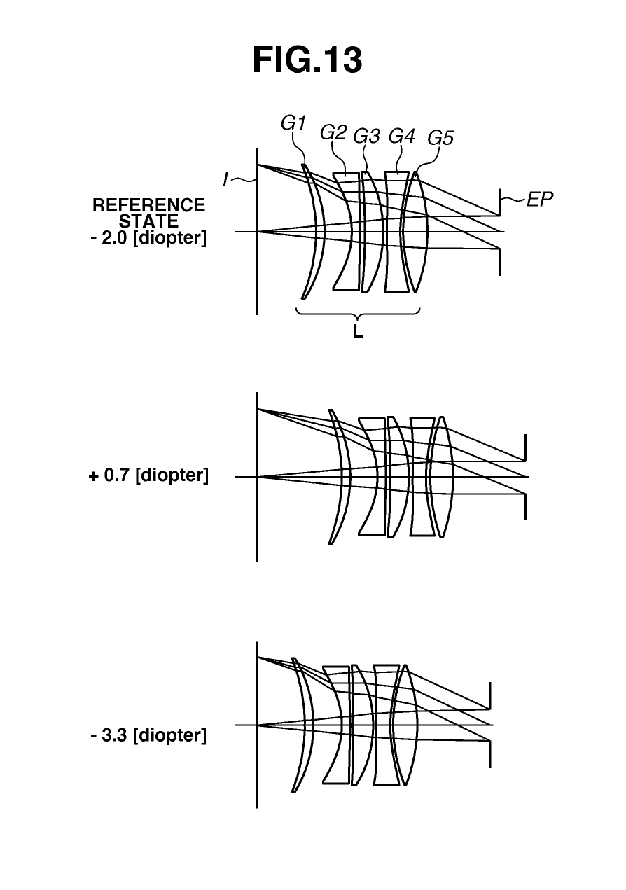

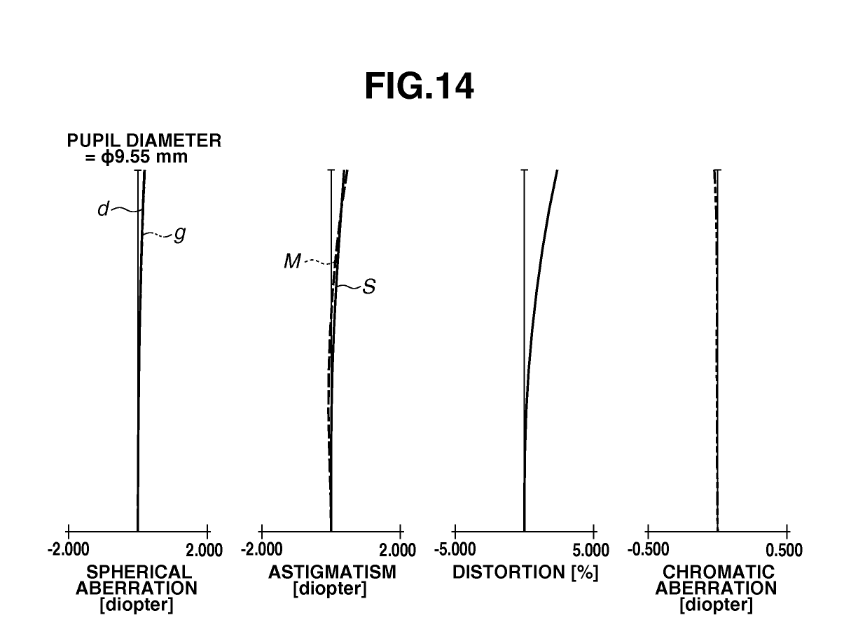

FIG. 13 is a lens cross-sectional view of a case where the diopter of an eyepiece lens of a seventh exemplary embodiment is −2.0 diopter (reference state), 0.7 diopter, and −3.3 diopter. FIG. 14 is aberration diagrams in the reference state of the eyepiece lens of the seventh exemplary embodiment.

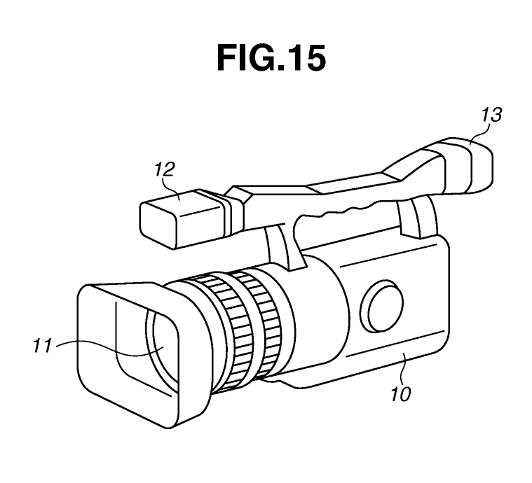

FIG. 15 is a schematic diagram of principal parts of an imaging apparatus including an eyepiece lens according to an exemplary embodiment of the present disclosure.

An eyepiece lens L of each of the exemplary embodiments is used in an electronic viewfinder of an imaging apparatus such as a digital camera or a video camera. In the lens cross-sectional view, the left-hand side is an image display surface side (object side), and the right-hand side is an observation side (eye point side). An image display surface I is an image display surface of an image display device such as a liquid crystal element or an organic EL element.

Eyepiece lenses L of the first, second, and seventh exemplary embodiments each consist of, in order from the object side to the observation side, a first lens G1 having positive refractive power, a second lens G2 having negative refractive power, a third lens G3 having positive refractive power, a fourth lens G4 having negative refractive power, and a fifth lens G5 having positive refractive power.

An eyepiece lens L of the third exemplary embodiment consists of, in order from the object side to the observation side, a first lens G1 having negative refractive power, a second lens G2 having positive refractive power, a third lens G3 having positive refractive power, a fourth lens G4 having positive refractive power, and a fifth lens G5 having negative refractive power.

Eyepiece lenses L of the fourth to sixth exemplary embodiments each consist of, in order from the object side to the observation side, a first lens G1 having positive refractive power, a second lens G2 having negative refractive power, a third lens G3 having positive refractive power, a fourth lens G4 having negative refractive power, a fifth lens G5 having positive refractive power, and a sixth lens having positive refractive power G6.

An eye point EP is used by a user to observe an image displayed on a display surface. A plate or the like for protecting the image display surface and the lenses may be provided between the image display surface I and a lens surface of the first lens G1 of the image display surface side. Further, a plate or the like for protecting the lenses may be provided between the eyepiece lens L and the eye point EP. Here, the eye point EP may be moved in an optical axis direction within a range where an off-axis ray emitted from the image display surface I can pass through a pupil of an observer.

Each of the aberration diagrams illustrates an aberration occurring in the eyepiece lens L of each of the exemplary embodiments when finder diopter is in a reference state.

The spherical aberration diagrams illustrate spheric aberration for a d line (a wavelength 587.6 nm) and a g line (a wavelength 435.8 nm). The astigmatism diagrams illustrate a sagittal image plane S and a meridional image plane M. The distortion diagrams illustrate a distortion for the d line. The chromatic aberration diagrams illustrate a chromatic aberration in the g line.

The eyepiece lens according to an exemplary embodiment of the present disclosure favorably corrects off-axis aberrations such as a distortion and a curvature of field by use of two or more resin lenses having a lens surface of an aspheric shape. Here, the resin lens means a lens made of a resin material. The resin lens may be a lens made of only a resin material, or may be a lens obtained in such a manner that nanoparticles such as indium tin oxide (ITO) or titanium oxide (TiO2) are dispersed in the resin material.

In the eyepiece lens according to an exemplary embodiment of the present disclosure, the lenses that constitute the eyepiece lens are substantially decreased in weight, by use of a resin having small specific gravity as material of the resin lens having a lens surface of an aspheric shape.

The lens surface of the resin lens can be more easily formed into the aspheric shape than a lens using glass material. Further, typically, the cost of the resin material is lower than the cost of the glass material. Therefore, as the material of the lens having an aspheric surface (hereinafter, described as aspheric lens), the resin material is used, so that the manufacturing cost and the cost of material can be decreased.

Typically, environment resistance of the resin material is lower than that of the glass material. For example, the resin material is softer than the glass material. Therefore, the resin lens is easily scratched. Further, when an antireflection film of metal oxide or the like is applied to the lens surface to decrease ghost and flare, since the resin material has lower adhesiveness than the glass material, the film can be easily peeled when the lens surface is wiped using solvent or the like. Further, the resin material has larger change of a refractive index and the shape along with temperature variation or humidity variation than the glass material, and an optical characteristic can be easily changed according to an external environment.

Therefore, in the eyepiece lens according to an exemplary embodiment of the present disclosure, the glass material is used as the material of a lens Le arranged closest to the observation side, so that the optical characteristic as the entire eyepiece lens is not largely changed even if the external environment is changed. Ultraviolet rays contained in sunlight and the like are absorbed by the lens (glass lens) made of the glass material, so that color change of the resin lens due to the ultraviolet rays can be prevented, and deterioration of the optical characteristic of the resin lens can be suppressed. Further, the glass lens is arranged between the resin lens and the external environment, so that the temperature variation or humidity variation of the resin lens is decreased. In this way, the resin material is arranged as far away as possible from the external environment, so that variation of the optical characteristic of the resin material with respect to the external environment can be suppressed.

Further, the eyepiece lens according to an exemplary embodiment of the present disclosure favorably corrects the off-axis aberrations such as a curvature of field and a distortion by use of two or more aspheric lenses.

In each of the exemplary embodiments, the material of all of resin lenses included in the eyepiece lens satisfies:

0.50<Rdens<1.50 (1)

where specific gravity of the resin material is Rdens.

As the resin material that satisfies the conditional expression (1), a cycloolefin resin, an acrylic resin (for example, polymethylmethacrylate (PMMA)), a polycarbonate resin, a polyester resin, and the like are known. An aspheric lens can be easily manufactured by injection molding of the resin material.

The specific gravity of a typical glass material is about 2.5 to 5.5. Therefore, the weight of the lens can be substantially decreased by use of the resin material that satisfies the conditional expression (1).

If the specific gravity of the resin material is too large exceeding a maximum value of the conditional expression (1), it becomes difficult to sufficiently reduce the weight of the eyepiece lens. Therefore, it is not favorable. Further, if the specific gravity of the resin material exceeds a minimum value of the conditional expression (1), resin material selectable as the lens material is limited. Therefore, it is not favorable.

In the eyepiece lens of each of the exemplary embodiments, an eyepiece lens that is light yet has high optical performance can be obtained by use of at least two aspheric lenses made of the resin material that satisfies the conditional expression (1).

In each of the exemplary embodiments, a numerical range of the conditional expression (1) is favorably set as follows:

0.70<Rdens<1.40 (1a)

Further, the numerical range of the conditional expression (1) is more favorably set as follows:

0.85<Rdens<1.35 (1b)

In the eyepiece lens L of each of the exemplary embodiments, diopter can be adjusted by integrally moving all of the lenses in an optical axis direction. By integrally moving all of the lenses, variation of a coma along with change of the diopter can be made small.

Further, in each of the exemplary embodiments, it is favorable to satisfy one or more conditional expressions of the conditional expressions below:

0.25<dr/D<0.95 (2)

1.55<ndr+0.0033×νdr<1.80 (3)

−2.5<f/fr<2.0 (4)

5.0<νdrn<35.0 (5)

−50.0×10⁻⁵/° C.<dnr/dT<−5.0×10⁻⁵/° C. (6)

1.450<ndE<2.100 (7)

1.60<fe2/D<12.00 (8)

where, a total sum of thicknesses on an optical axis of all of the lenses included in the eyepiece lens is D, a total sum of thicknesses on the optical axis of all of the resin lenses included in the eyepiece lens is dr, a refractive index of the material of the resin lenses included in the eyepiece lens based on the d line is ndr, an Abbe number is νdr, a focal length of the resin lens included in the eyepiece lens is fr, a focal length of the entire zoom lens of the eyepiece lens is f, an Abbe number of the material of the resin lens having negative refractive power included in the eyepiece lens based on the d line is νdrn, a temperature coefficient of the refractive index of the material of the resin lenses included in the eyepiece lens based on the d line is dnr/dT, a refractive index of the material of the lens Le arranged closest to the observation side of the eyepiece lens based on the d line is ndE, and a composite focal length of the lens Le and a lens arranged adjacent to the object side of the lens Le is fe2.

Here, the Abbe number νd is a numerical value expressed by:

νd=(Nd−1)/(NF−NC)

where refractive indexes of the material with respect to an F line (486.1 nm), a C line (656.3 nm), and the d line (587.6 nm) are respectively NF, NC, and Nd.

The conditional expression (2) defines a ratio of the total sum D of the thicknesses on the optical axis of all of the lenses included in the eyepiece lens, and the total sum dr of the thicknesses on the optical axis of all of resin lenses included in the eyepiece lens.

If the total sum dr of the thicknesses on the optical axis of the resin lenses becomes too small exceeding a minimum value of the conditional expression (2), the thickness of the lens made of the glass material becomes large, and the weight of the eyepiece lens is increased. Therefore, it is not favorable.

If the total sum dr of the thicknesses on the optical axis of the resin lenses becomes too large exceeding a maximum value of the conditional expression (2), change of the optical characteristic along with change of the external environment becomes large, and a decrease in the optical performance is incurred. Therefore, it is not favorable.

The conditional expression (3) defines the material of the resin lens included in the eyepiece lens. If the refractive index ndr of the resin material becomes low exceeding a minimum value of the conditional expression (3), it becomes difficult to sufficiently strengthen the refractive power of the resin lens, and it becomes difficult to sufficiently obtain an effect to cancel an aberration among a plurality of resin lenses. Therefore, it is not favorable. Further, if a curvature of the lens surface of the resin lens is made large to strengthen the refractive power of the resin lens, a lot of high order aberrations occur. Therefore, it is not favorable.

If the refractive index ndr of the resin material becomes high exceeding a maximum value of the conditional expression (3), resin material selectable as the lens material is limited. Therefore, it is not favorable.

The conditional expression (4) defines a ratio of the focal length f of the entire zoom lens of the eyepiece lens, and the focal length fr of the resin lens included in the eyepiece lens.

If the negative refractive power of the resin lens becomes too strong exceeding a minimum value of the conditional expression (4), the curvature of the lens surface of the resin lens becomes too large. Typically, the resin material has a lower refractive index than the glass material. Therefore, to strengthen the refractive power of the resin lens, it is necessary to make the curvature of the lens surface large. If the curvature of the lens surface of the resin lens becomes too large, a lot of high order aberrations occur. Therefore, it is not favorable.

If the positive refractive power of the resin lens becomes too strong exceeding a maximum value of the conditional expression (4), the curvature of the lens surface of the resin lens becomes too large. If the curvature of the lens surface of the resin lens becomes too large, a lot of high order aberrations occur. Therefore, it is not favorable.

The conditional expression (5) is a conditional expression that defines the Abbe number νdrn of the material of the resin lens having negative refractive power. The chromatic aberration is favorably corrected by arranging a negative lens made of a highly dispersed material in the eyepiece lens having positive refractive power as a whole.

If the Abbe number νdrn of the material of the resin lens having negative refractive power becomes small exceeding a minimum value of the conditional expression (5), the chromatic aberration is excessively corrected. Therefore, it is not favorable. Further, resin material selectable as the lens material is limited. Therefore, it is not favorable. If the Abbe number νdrn of the material of the resin lens having negative refractive power becomes large exceeding a maximum value of the conditional expression (5), it becomes difficult to sufficiently correct the chromatic aberration in the eyepiece lens. Therefore, it is not favorable.

The conditional expression (6) is a conditional expression that defines the temperature coefficient of the refractive index dnr/dT of the material of the resin lens included in the eyepiece lens based on the d line.

If the value of the temperature coefficient dnr/dT becomes large exceeding a minimum value of the conditional expression (6), an amount of change of the refractive index with respect to temperature change becomes too large, and variation of the curvature of field or the astigmatism becomes large. Further, shift of the diopter along with the temperature change becomes large. Therefore, it is not favorable.

If the value of the temperature coefficient dnr/dT becomes small exceeding a maximum value of the conditional expression (6), resin material selectable as the lens material is limited. Therefore, it is not favorable.

The conditional expression (7) is a conditional expression that defines the refractive index ndE of the material of the lens Le arranged closest to the observation side of the eyepiece lens.

If the refractive index ndE of the material of the lens Le becomes too small exceeding a minimum value of the conditional expression (7), it is necessary to make a curvature of the lens Le large to secure the refractive power of the lens Le. As a result, it becomes difficult to sufficiently correct aspheric aberration and a comma occurring in the lens Le. Therefore, it is not favorable.

If the refractive index ndE of the material of the lens Le becomes too large exceeding a maximum value of the conditional expression (7), material selectable as the lens material is limited. Therefore, it is not favorable.

The conditional expression (8) is a conditional expression that defines a ratio of the composite focal length fe2 of the lens Le and the lens arranged adjacent to the object side of the lens Le, and the total sum D of the thicknesses on the optical axis of all of the lenses included in the eyepiece lens.

If the composite focal length fe2 of the lens Le and the lens arranged adjacent to the object side of the lens Le becomes too short exceeding a minimum value of the conditional expression (8), the refractive power of the lens arranged at the observation side becomes too strong. As a result, an angle of a light ray passing through a peripheral portion of the eyepiece lens is largely changed, and a peripheral portion of a field of view is more likely to become dark with respect to change of the eye point. Therefore, it is not favorable.

If the composite focal length fe2 of the lens Le and the lens arranged adjacent to the object side of the lens Le becomes too long exceeding a maximum value of the conditional expression (8), the refractive power of the lens arranged at the observation side becomes too weak. As a result, it becomes difficult to sufficiently correct the various aberrations in the lens arranged at the observation side. Therefore, it is not favorable.

Effects brought about by the conditional expressions can be obtained to a maximum extent if numerical ranges of the conditional expressions (2) to (8) are favorably set as follows.

0.30<dr/D<0.93 (2a)

1.60<ndr+0.0033×νdr<1.77 (3a)

−2.0<f/fr<1.6 (4a)

15.0<νdrn<30.0 (5a)

−30.0×10⁻⁵/° C.<dn/dT<−7.0×10⁻⁵/° C. (6a)

1.510<ndE<1.950 (7a)

1.80<fe2/D<9.00 (8a)

The numerical ranges of the conditional expressions (2) to (8) are more favorably set as follows:

0.35<dr/D<0.92 (2b)

1.65<ndr+0.0033×νdr<1.75 (3b)

−1.8<f/fr<1.2 (4b)

18.0<νdrn<28.0 (5b)

−20.0×10⁻⁵/° C.<dn/dT<−9.0×10⁻⁵/° C. (6b)

1.550<ndE<1.850 (7b)

2.00<fe2/D<6.00 (8b)

Further, when the eyepiece lens L of each of the exemplary embodiments is used for an observation device used to observe image information displayed on the image display surface I, it is favorable to satisfy a conditional expression below:

0.50<H/f<1.20 (9)

where a diagonal length of the image display surface I is H.

The conditional expression (9) is a conditional expression that defines a ratio of the diagonal length H of the image display surface I and the focal length f of the eyepiece lens.

If the focal length f of the eyepiece lens becomes too long exceeding a minimum value of the conditional expression (9), an angle of view becomes too narrow. Therefore, it is not favorable.

If the focal length f of the eyepiece lens becomes too short exceeding a maximum value of the conditional expression (9), an effective diameter of the lens arranged at the observation side becomes too large. As a result, a lot of off-axis aberrations such as a coma and an astigmatism occur in the lens arranged at the observation side. Therefore, it is not favorable.

In each of the exemplary embodiments, a numerical range of the conditional expression (9) is favorably set as follows:

0.55<H/f<1.00 (9a)

Further, the numerical range of the conditional expression (9) is more favorably set as follows:

0.60<H/f<0.90 (9b)

The eyepiece lens according to an exemplary embodiment of the present disclosure includes five or more lenses including the resin lens having a lens surface of an aspheric shape.

In the eyepiece lens according to an exemplary embodiment of the present disclosure, a resin having small specific gravity is used as the material of the resin lens having a lens surface of an aspheric shape, so that the weight of the lenses that constitute the eyepiece lens is substantially reduced.

The lens surface of the resin lens can be more easily formed into the aspheric shape than a lens formed of glass material. Further, the cost of the resin material is lower than the cost of the glass material. Therefore, as the material of the lens having an aspheric surface (hereinafter, described as aspheric lens), the resin material is used, so that the manufacturing cost and the cost of material can be decreased.

Meanwhile, the resin material has larger change of the refractive index and the shape along with temperature variation or humidity variation than the glass material, and the optical characteristic can be easily changed according to the external environment. Therefore, in the eyepiece lens according to an exemplary embodiment of the present disclosure, a lens made of the glass material is arranged to each of the object side and the observation side of the resin lens, so that the optical characteristic as the entire eyepiece lens is not largely changed even if the external environment is changed.

Further, to realize an eyepiece lens having a long eye relief and a large angle of view yet having favorable optical performance, it is necessary to increase the number of lenses that constitute the eyepiece lens. Therefore, the eyepiece lens according to an exemplary embodiment of the present disclosure includes five or more lenses.

The eyepiece lens of each of the exemplary embodiments includes a resin lens R that satisfies a conditional expression below:

5.0<νd<30.0 (10)

where an Abbe number of the material of the lens based on the d line is νd.

Here, the Abbe number νd is a numerical value expressed by:

νd=(Nd−1)/(NF−NC)

where refractive indexes of the material with respect to the F line (486.1 nm), the C line (656.3 nm), and the d line (587.6 nm) are respectively NF, NC, and Nd.

The conditional expression (10) is a conditional expression that defines the Abbe number νd of the material of the resin lens R. If the Abbe number νd of the material of the resin lens R becomes small exceeding a minimum value of the conditional expression (10), the chromatic aberration is excessively corrected. Therefore, it is not favorable. Further, resin material selectable as the lens material is limited. Therefore, it is not favorable. If the Abbe number νd of the material of the resin lens R becomes large exceeding a maximum value of the conditional expression (10), it becomes difficult to sufficiently correct the chromatic aberration in the eyepiece lens. Therefore, it is not favorable.

In the eyepiece lens of each of the exemplary embodiments, an eyepiece lens that is light yet has high optical performance can be obtained by use of the aspheric lens made of the resin material that satisfies the conditional expression (10).

In each of the exemplary embodiments, a numerical range of the conditional expression (10) is favorably set as follows:

10.0<νd<27.0 (10a)

Further, the numerical range of the conditional expression (10) is more favorably set as follows:

20.0<νd<25.0 (10b)

In the eyepiece lens L of each of the exemplary embodiments, the diopter can be adjusted by integrally moving all of the lenses in the optical axis direction. By integrally moving all of the lenses, variation of a coma generated along with change of the diopter can be made small.

Further, in each of the exemplary embodiments, it is favorable to satisfy one or more conditional expressions of the conditional expressions below:

−15.00<fR/f<0.00 (11)

0.30<|R1+R2|/|R1−R2|<20.00 (12)

1.450<ndE<2.100 (13)

Here, a focal length of the resin lens R is fR, the focal length of the entire zoom lens of the eyepiece lens is f, a curvature radius of a lens surface at the object side of the resin lens R is R1, and a curvature radius of a lens surface at the observation side of the resin lens R is R2. Further, a refractive index of the material of the lens arranged closest to the observation side in the eyepiece lens based on the d line is ndE.

The conditional expression (11) defines a ratio of the focal length fR of the resin lens R and the focal length f of the entire zoom lens of the eyepiece lens.

If the focal length fR of the resin lens R becomes long exceeding a minimum value of the conditional expression (11), the refractive power of the resin lens R becomes too weak, and it becomes difficult to sufficiently correct the chromatic aberration. Therefore, it is not favorable.

If the focal length fR of the resin lens R becomes short exceeding the maximum value of the conditional expression (11), the refractive power of the resin lens R becomes too strong. To strengthen the refractive power of the resin lens R, it is necessary to make a curvature of the lens surface of the resin lens R large, and a lot of high order aberration occur. Therefore, it is not favorable.

The conditional expression (12) defines a shape factor of the resin lens R. If a minimum value of the conditional expression (12) is exceeded, a curvature radius of either the lens surface at the object side of the resin lens R or the lens surface at the observation side of the resin lens R becomes too small. As a result, a light ray incident from the image display surface side is largely diverged by the resin lens R. Therefore, an effective diameter of the lens arranged closer to the observation side of the resin lens R is increased. Therefore, it is not favorable.

If a maximum value of the conditional expression (12) is exceeded, a difference between the curvature radius R1 of the lens surface at the object side and the curvature radius R2 of the lens surface at the observation side, of the resin lens R, becomes too small. As a result, it becomes especially difficult to favorably correct a coma. Therefore, it is not favorable.

The conditional expression (13) is a conditional expression that defines the refractive index ndE of the material of the lens arranged closest to the observation side of the eyepiece lens.

If the refractive index ndE of the material of the lens arranged closest to the observation side of the eyepiece lens becomes too small exceeding a minimum value of the conditional expression (13), it is necessary to make a curvature of the lens arranged closest to the observation side of the eyepiece lens large to secure the refractive power. As a result, it becomes difficult to sufficiently correct aspheric aberration or a coma occurring in the lens arranged closest to the observation side of the eyepiece lens. Therefore, it is not favorable.

It the refractive index ndE of the material of the lens arranged closest to the observation side of the eyepiece lens becomes too large exceeding a maximum value of the conditional expression (13), materials selectable as the lens material is limited. Therefore, it is not favorable.

Effects brought about by the conditional expressions can be obtained to a maximum extent if numerical ranges of the conditional expressions (11) to (13) are favorably set as follows:

−13.00<fR/f<−0.40 (11a)

0.50<|R1+R2|/|R1−R2|<15.00 (12a)

1.510<ndE<1.950 (13a)

The numerical ranges of the conditional expressions (11) to (13) are more favorably set as follows:

−12.00<fR/f<−0.50 (11b)

0.65<|R1+R2|/|R1−R2|<12.00 (12b)

1.760<ndE<1.850 (13b)

Further, when the eyepiece lens L of each of the exemplary embodiments is used for an observation device used to observe an image displayed on the image display surface I, it is favorable to satisfy a conditional expression below:

0.52<H/f<0.91 (14)

where, the diagonal length of the image display surface I is H.

The conditional expression (14) is a conditional expression that defines a ratio of the diagonal length H of the image display surface I and the focal length f of the eyepiece lens.

If the focal length f of the eyepiece lens becomes too long exceeding a minimum value of the conditional expression (14), the angle of view becomes too narrow. Therefore, it is not favorable.

If the focal length f of the eyepiece lens becomes too short exceeding a maximum value of the conditional expression (14), the effective diameter of the lens arranged at the observation side becomes too large. As a result, a lot of off-axis aberrations such as a coma and an astigmatism occur in the lens arranged at the observation side. Therefore, it is not favorable.

In each of the exemplary embodiments, a numerical range of the conditional expression (14) is favorably set as follows:

0.55<H/f<0.88 (14a)

Further, the numerical range of the conditional expression (14) is more favorably set as follows:

0.60<H/f<0.85 (14b)

Next, a lens configuration of the eyepiece lens of each of the exemplary embodiments will be described. The eyepiece lens of the first exemplary embodiment includes, in order from the image display surface side to the observation side, the first lens G1 having positive refractive power, the second lens G2 having negative refractive power, the third lens G3 having positive refractive power, the fourth lens G4 having negative refractive power, and the fifth lens G5 having positive refractive power. The second lens G2 having negative refractive power, the third lens G3 having positive refractive power, and the fourth lens G4 having negative refractive power are the resin lenses.

The material of the second lens G2 and the fourth lens G4 is a polycarbonate resin (the specific gravity is 1.24, the temperature coefficient of the refractive index dn/dT=−12.0×10⁻⁵, and a water absorption coefficient is 0.35%). The material of the third lens G3 is a cycloolefin resin (the specific gravity is 1.01, the temperature coefficient of the refractive index dn/dT=−11.0×10⁻⁵, and the water absorption coefficient is smaller than 0.01%). The lens surfaces of the second lens G2, the third lens G3, and the fourth lens G4 are formed into the aspheric shape, so that the coma, the astigmatism, the distortion, and the like are favorably corrected.

A finder including the eyepiece lens of the first exemplary embodiment has the diagonal length H of the image display surface=18.2 mm, the eye relief of 27.0 mm, and the angle of view of 35.0 degrees.

The eyepiece lens of the second exemplary embodiment includes, in order from the image display surface side to the observation side, the first lens G1 having positive refractive power, the second lens G2 having negative refractive power, the third lens G3 having positive refractive power, the fourth lens G4 having negative refractive power, and the fifth lens G5 having positive refractive power. The second lens G2 having negative refractive power, the third lens G3 having positive refractive power, and the fourth lens G4 having negative refractive power are the resin lenses.

The material of the second lens G2 and the fourth lens G4 is a polycarbonate resin (the specific gravity is 1.24, the temperature coefficient of the refractive index dn/dT=−12.0×10⁻⁵, and the water absorption coefficient is 0.35%). The material of the third lens G3 is a methacrylic resin (the specific gravity is 1.19, the temperature coefficient of the refractive index dn/dT=13.0×10⁻⁵, and the water absorption coefficient is 0.3%). The lens surfaces of the first lens G1, the second lens G2, the third lens G3, the fourth lens G4, and the fifth lens G5 are formed into the aspheric shape, so that the coma, the astigmatism, the distortion, and the like are favorably corrected.

A finder including the eyepiece lens of the second exemplary embodiment has the diagonal length H of the image display surface=76.2 mm, the eye relief of 27.0 mm, and the angle of view of 45.0 degrees.

The eyepiece lens of the third exemplary embodiment includes, in order from the image display surface side to the observation side, the first lens G1 having negative refractive power, the second lens G2 having positive refractive power, the third lens G3 having positive refractive power, the fourth lens G4 having positive refractive power, and the fifth lens G5 having negative refractive power. The third lens G3 having positive refractive power and the fourth lens G4 having positive refractive power are the resin lenses.

The material of the third lens G3 and the fourth lens G4 is a methacrylic resin (the specific gravity is 1.19, the temperature coefficient of the refractive index do/dT=−13.0×10⁻⁵, and the water absorption coefficient is 0.3%). Surfaces of a part of the resin lenses are formed into the aspheric shape, so that the coma, the astigmatism, the distortion, and the like are favorably corrected.

Further, a difference between the Abbe number of the material of the first lens G1 having negative refractive power and the Abbe number of the material of the second lens G2 having positive refractive power are made large, so that a decrease in an axial chromatic aberration and a lateral chromatic aberration is realized.

A finder including the eyepiece lens of the third exemplary embodiment has the diagonal length H of the image display surface=32.0 mm, the eye relief of 30.0 mm, and the angle of view of 35.0 degrees.

The eyepiece lens of the fourth exemplary embodiment includes, in order from the image display surface side to the observation side, the first lens G1 having positive refractive power, the second lens G2 having negative refractive power, the third lens G3 having positive refractive power, the fourth lens G4 having negative refractive power, the fifth lens G5 having positive refractive power, and the sixth lens having positive refractive power G6. The first lens G1 having positive refractive power, the second lens G2 having negative refractive power, the third lens G3 having positive refractive power, the fourth lens G4 having negative refractive power, and the fifth lens G5 having positive refractive power are the resin lenses.

The material of the first lens G1, the third lens G3, and the fifth lens G5 is a cycloolefin resin (the specific gravity is 1.01, the temperature coefficient of the refractive index dn/dT=−11.0×10⁻⁵, and the water absorption coefficient is smaller than 0.01%). The material of the second lens G2 and the fourth lens G4 is a polycarbonate resin (the specific gravity is 1.24, the temperature coefficient of the refractive index dn/dT=12.0×10⁻⁵, and the water absorption coefficient is 0.35%).

The lens surfaces of the first lens G1, the second lens G2, the third lens G3, and the fourth lens G4 are formed into the aspheric shape, so that the coma, the astigmatism, the distortion, and the like are favorably corrected.

A finder including the eyepiece lens of the fourth exemplary embodiment has the diagonal length H of the image display surface=38.1 mm, the eye relief of 27.0 mm, and the angle of view of 40.0 degrees.

The eyepiece lens of the fifth exemplary embodiment includes, in order from the image display surface side to the observation side, the first lens G1 having positive refractive power, the second lens G2 having negative refractive power, the third lens G3 having positive refractive power, the fourth lens G4 having negative refractive power, the fifth lens G5 having positive refractive power, and the sixth lens having positive refractive power G6. The second lens G2 having negative refractive power, the third lens G3 having positive refractive power, and the fourth lens G4 having negative refractive power are the resin lenses.

The material of the second lens G2 and the fourth lens G4 is a polycarbonate resin (the specific gravity is 1.24, the temperature coefficient of the refractive index do/dT=−12.0×10⁻⁵, and the water absorption coefficient is 0.35%). The material of the third lens G3 is a cycloolefin resin (the specific gravity is 1.01, the temperature coefficient of the refractive index do/dT=−11.0×10⁻⁵, and the water absorption coefficient is smaller than 0.01%). The lens surfaces of the second lens G2, the third lens G3, and the fourth lens G4 are formed into the aspheric shape, so that the coma, the astigmatism, the distortion, and the like are favorably corrected.

A finder including the eyepiece lens of the fifth exemplary embodiment has the diagonal length H of the image display surface=76.2 mm, the eye relief of 27.0 mm, and the angle of view of 40.0 degrees.

The eyepiece lens of the sixth exemplary embodiment includes, in order from the image display surface side to the observation side, the first lens G1 having positive refractive power, the second lens G2 having negative refractive power, the third lens G3 having positive refractive power, the fourth lens G4 having negative refractive power, the fifth lens G5 having positive refractive power, and the sixth lens G6 having positive refractive power. The second lens G2 having negative refractive power, the third lens G3 having positive refractive power, the fourth lens G4 having negative refractive power, and the fifth lens G5 having positive refractive power are the resin lenses.

The material of the second lens G2 and the fourth lens G4 is a polycarbonate resin (the specific gravity is 1.24, the temperature coefficient of the refractive index dn/dT=−12.0×10⁻⁵, and the water absorption coefficient is 0.35%). The material of the third lens G3 and the fifth lens G5 is a cycloolefin resin (the specific gravity is 1.01, the temperature coefficient of the refractive index dn/dT=−11.0×10⁻⁵, and the water absorption coefficient is smaller than 0.01%). The lens surfaces of the first lens G1, the second lens G2, the third lens G3, the fourth lens G4, and the fifth lens G5 are formed into the aspheric shape, so that the coma, the astigmatism, the distortion, and the like are favorably corrected.

A finder including the eyepiece lens of the sixth exemplary embodiment has the diagonal length H of the image display surface=38.1 mm, the eye relief of 27.0 mm, and the angle of view of 45.0 degrees.

The eyepiece lens of the seventh exemplary embodiment includes, in order from the image display surface side to the observation side, the first lens G1 having positive refractive power, the second lens G2 having negative refractive power, the third lens G3 having positive refractive power, the fourth lens G4 having negative refractive power, and the fifth lens G5 having positive refractive power. The fourth lens G4 having negative refractive power is the resin lens. The material of the fourth lens G4 is a polycarbonate resin (the specific gravity is 1.24, the temperature coefficient of the refractive index dn/dT=−12.0×10⁻⁵, and the water absorption coefficient is 0.35%). The lens surfaces of the third lens G3 and the fourth lens G4 are formed into the aspheric shape, so that the coma, the astigmatism, the distortion, and the like are favorably corrected.

A finder including the eyepiece lens of the seventh exemplary embodiment has the diagonal length H of the image display surface=50.8 mm, the eye relief of 27.0 mm, and the angle of view of 45.0 degrees.

The eyepiece lenses of the first, second, fourth, fifth, sixth, and seventh exemplary embodiments include at least one resin lens having positive refractive power and one resin lens having negative refractive power. Accordingly, variation of the aberration and shift of the diopter generated along with the temperature change can be favorably cancelled.

Further, the eyepiece lens of each of the exemplary embodiments includes two or more lens having negative refractive power. A plurality of negative lenses is arranged in the eyepiece lens having positive refractive power as a whole, so that the axial chromatic aberration and the lateral chromatic aberration can be favorably corrected. The eyepiece lens includes two or more lenses having positive refractive power and two or more lenses having negative refractive power, so that the axial chromatic aberration and the lateral chromatic aberration can be more favorably corrected.

Further, the eyepiece lens of each of the exemplary embodiments includes a resin lens made of a thermoplastic resin. The thermoplastic resin is easily softened when heated. Therefore, the resin lens can be easily formed. By use of the lens including the thermoplastic resin, the manufacturing cost of the eyepiece lens can be reduced.

Next, first to seventh numerical examples respectively corresponding to the first to seventh exemplary embodiments of the present disclosure are described. In each of the numerical examples, i represents an order of an optical surface from the image display surface side. ri represents a curvature radius of the i-th optical surface (the i-th surface), di represents a distance between the i-th surface and the (i+1)-th surface, ndi and νdi respectively represent the refractive index and the Abbe number of the material of the i-th optical member based on the d line. r1 represents the image display surface, and a surface closest to the observation side represents the eye point EP.

Further, the aspheric shape is expressed by:

x=(h²/R)/[1+[1−(1+k)(h/R)²]^{1/2}]+A4h⁴+A6h⁶+A8h⁸

where k is eccentricity, A4, A6, and A8 are aspheric coefficients, and displacement in the optical axis direction at a position having a height h from the optical axis based on a surface vertex is x. Note that R is a paraxial curvature radius. The surface with * at the right of a surface number means that this surface is aspheric. Further, display of “e-Z” means “10^{-z}”.

### First Numerical Example

Unit mm
Surface Data

| Surface Number | r | d | nd | νd |
|---|---|---|---|---|
| 1 | ∞ | 0.70 | 1.51000 | 60.0 |
| 2 | ∞ | (variable) | | |
| 3 | −65.737 | 3.95 | 2.00069 | 25.5 |
| 4 | −22.170 | 3.52 | | |
| 5* | −14.334 | 3.00 | 1.63550 | 23.8 |
| 6* | 110.330 | 0.30 | | |
| 7* | 48.492 | 6.84 | 1.53110 | 55.9 |
| 8* | −21.874 | 1.20 | | |
| 9* | 128.789 | 1.41 | 1.63550 | 23.8 |
| 10* | 22.276 | 1.20 | | |
| 11 | 39.057 | 8.21 | 1.83481 | 42.7 |
| 12 | −39.057 | 27.00 | | |
| 13 (eye point) | | | | |

Aspheric Surface Data

5th surface

| | | |
|---|---|---|
| K = −7.28787e−001 | A 4 = −6.03675e−005 | A 6 = 1.77471e−007 |

6th surface

| | | |
|---|---|---|
| K = 4.51650e+001 | A 4 = −1.11796e−005 | A 6 = −6.19143e−008 |

7th surface

| | | |
|---|---|---|
| K = −4.38548e+000 | A 4 = −2.38798e−005 | A 6 = −2.65742e−008 |

8th surface

| | | |
|---|---|---|
| K = −1.22703e+000 | A 4 = −4.69821e−006 | A 6 = 3.91413e−008 |

9th surface

| | | |
|---|---|---|
| K = −2.69921e+002 | A 4 = −1.528816−007 | A 6 = −4.63945e−009 |

10th surface

| | | |
|---|---|---|
| K = −4.63925e+000 | A 4 = 4.39848e−006 | A 6 = 5.19693e−010 |

Various Data

| | | | |
|---|---|---|---|
| Diopter [diopter] | −2.0 | +2.5 | −6.0 |
| Focal Length | 28.56 | 28.56 | 28.56 |
| d 2 | 9.12 | 12.79 | 5.80 |

### Second Numerical Example

Unit mm
Surface Data

| Surface Number | r | d | nd | νd |
|---|---|---|---|---|
| 1 | ∞ | 0.70 | 1.51000 | 60.0 |
| 2 | ∞ | (variable) | | |
| 3* | −98.827 | 11.19 | 1.85135 | 40.1 |
| 4* | −71.371 | 20.00 | | |
| 5* | −49.765 | 3.00 | 1.63550 | 23.8 |
| 6* | −407.575 | 1.11 | | |
| 7* | −1171.461 | 7.94 | 1.49171 | 57.4 |
| 8* | −82.367 | 1.20 | | |
| 9* | 219.883 | 3.76 | 1.63550 | 23.8 |
| 10* | 74.863 | 1.23 | | |
| 11* | 95.021 | 8.12 | 1.80610 | 40.7 |
| 12* | −92.616 | 27.00 | | |
| 13 (eye point) | | | | |

Aspheric Surface Data

3rd surface

| | | |
|---|---|---|
| K = 4.54099e−001 | A 4 = 3.40725e−008 | A 6 = 7.53032e−011 |
| A 8 = −1.51639e−013 | | |

4th surface

| | | |
|---|---|---|
| K = 3.40970e−001 | A 4 = 8.48720e−008 | A 6 = −4.76459e−011 |
| A 8 = 1.79616e−014 | | |

5th surface

K = 3.53841e−001

6th surface

K = −1.00057e+003

7th surface

| | | |
|---|---|---|
| K = −2.99780e+003 | A 4 = −5.75156e−006 | A 6 = 7.03535e−009 |

8th surface

| | | |
|---|---|---|
| K = −1.18365e+000 | A 4 = 4.34382e−006 | A 6 = −5.53385e−009 |

9th surface

| | | |
|---|---|---|
| K = 1.75400e+001 | A 4 = −2.52412e−006 | A 6 = −7.75632e−009 |

10th surface

| | | |
|---|---|---|
| K = −1.05760e+001 | A 4 = −6.88282e−006 | A 6 = 3.02568e−009 |

11th surface

K = 3.83428e+000

12th surface

K = 1.63448e+000

Various Data

| | | | |
|---|---|---|---|
| Diopter [diopter] | −2.0 | +2.0 | −4.0 |
| Focal Length | 91.98 | 91.98 | 91.98 |
| d 2 | 31.59 | 66.08 | 20.00 |

### Third Numerical Example

Unit mm
Surface Data

| Surface Number | r | d | nd | νd |
|---|---|---|---|---|
| 1 | ∞ | 0.70 | 1.51000 | 60.0 |
| 2 | ∞ | (variable) | | |
| 3 | −18.559 | 1.00 | 1.64769 | 33.8 |
| 4 | 405.260 | 8.54 | 1.69350 | 53.2 |
| 5* | −30.810 | 1.18 | | |
| 6* | 161.494 | 7.67 | 1.49171 | 57.4 |
| 7 | −38.921 | 0.10 | | |
| 8* | 48.932 | 8.43 | 1.49171 | 57.4 |
| 9 | −97.046 | 0.10 | | |
| 10 | 33.326 | 1.20 | 1.69895 | 30.1 |
| 11 | 22.887 | 30.00 | | |
| 12 (eye point) | | | | |

Aspheric Surface Data

5th surface

K = −6.54146e−003

6th surface

| | | |
|---|---|---|
| K = −2.64204e+002 | A 4 = −3.16425e−006 | A 6 = −2.31819e−009 |

8th surface

K = 1.87604e+000

Various Data

| | | | |
|---|---|---|---|
| Diopter [diopter] | −2.0 | +2.5 | −6.0 |
| Focal Length | 50.29 | 50.29 | 50.29 |
| d 2 | 28.47 | 40.02 | 20.00 |

### Fourth Numerical Example

Unit mm
Surface Data

| Surface Number | r | d | nd | νd |
|---|---|---|---|---|
| 1 | ∞ | 0.70 | 1.51000 | 60.0 |
| 2 | ∞ | (variable) | | |
| 3* | 166.099 | 9.26 | 1.53110 | 55.9 |
| 4* | −34.164 | 6.60 | | |
| 5* | −28.931 | 3.82 | 1.63550 | 23.8 |
| 6* | −93.400 | 0.47 | | |
| 7* | −153.697 | 3.79 | 1.53110 | 55.9 |
| 8* | −50.254 | 2.12 | | |
| 9* | −40.174 | 6.83 | 1.63550 | 23.8 |
| 10* | −56.296 | 1.20 | | |
| 11 | −3131.870 | 4.55 | 1.53110 | 55.9 |
| 12 | −62.412 | 1.20 | | |
| 13 | 110.718 | 3.36 | 1.49700 | 81.5 |
| 14 | −332.326 | 27.00 | | |
| 15 (eye point) | | | | |

Aspheric Surface Data

3rd surface

| | | |
|---|---|---|
| K = −9.59406e+001 | A 4 = −2.43307e−006 | A 6 = −5.82983e−009 |

4th surface

| | | |
|---|---|---|
| K = 3.24062e−001 | A 4 = 2.14830e−006 | A 6 = 2.81943e−009 |

5th surface

| | | |
|---|---|---|
| K = 9.32664e−002 | A 4 = −5.63898e−007 | A 6 = 2.57659e−008 |

6th surface

| | | |
|---|---|---|
| K = −8.05489e+000 | A 4 = 6.49218e−007 | A 6 = −1.63252e−010 |

7th surface

| | | |
|---|---|---|
| K = −4.96939e+001 | A 4 = −1.17845e−006 | A 6 = −4.58865e−009 |

8th surface

| | | |
|---|---|---|
| K = 2.90402e−001 | A 4 = −2.46377e−006 | A 6 = 5.28440e−009 |

9th surface

| | | |
|---|---|---|
| K = −1.87452e−001 | A 4 = 1.66992e−006 | A 6 = −7.39182e−009 |

10th surface

| | | |
|---|---|---|
| K = 2.96336e+000 | A 4 = 4.16642e−007 | A 6 = 1.08928e−009 |

Various Data

| | | | |
|---|---|---|---|
| Diopter [diopter] | −2.0 | +2.0 | −4.0 |
| Focal Length | 52.34 | 52.34 | 52.34 |
| d 2 | 22.29 | 33.23 | 17.21 |

### Fifth Numerical Example

Unit mm
Surface Data

| Surface Number | r | d | nd | νd |
|---|---|---|---|---|
| 1 | ∞ | 0.70 | 1.51000 | 60.0 |
| 2 | ∞ | (variable) | | |
| 3 | −1201.003 | 20.00 | 1.48749 | 70.2 |
| 4 | −89.718 | 20.00 | | |
| 5* | −64.550 | 3.06 | 1.63550 | 23.8 |
| 6* | −160.023 | 2.00 | | |
| 7* | −230.109 | 3.54 | 1.53110 | 55.9 |
| 8* | −119.762 | 1.20 | | |
| 9* | −86.800 | 12.72 | 1.63550 | 23.8 |
| 10* | −103.753 | 1.20 | | |
| 11 | 5354.752 | 4.23 | 1.60311 | 60.6 |
| 12 | −123.568 | 1.20 | | |
| 13 | 178.678 | 3.96 | 1.51633 | 64.1 |
| 14 | −395.781 | 27.00 | | |
| 15 (eye point) | | | | |

Aspheric Surface Data

5th surface

| | |
|---|---|
| K = 2.64919e+000 | A 4 = −7.42759e−007 |

6th surface

| | |
|---|---|
| K = −6.77987e+001 | A 4 = −2.49183e−008 |

7th surface

| | |
|---|---|
| K = 6.98083e+001 | A 4 = −1.18509e−006 |

8th surface

| | | |
|---|---|---|
| K = 5.02189e+000 | A 4 = −2.98254e−006 | A 6 = −1.01200e−009 |

9th surface

| | |
|---|---|
| K = 2.92913e+000 | A 4 = 1.34769e−006 |

10th surface

| | |
|---|---|
| K = 1.50370e+000 | A 4 = −8.31493e−007 |

Various Data

| | | | |
|---|---|---|---|
| Diopter [diopter] | −2.0 | +2.0 | −4.0 |
| Focal Length | 104.68 | 104.68 | 104.68 |
| d 2 | 32.12 | 76.83 | 17.13 |

### Sixth Numerical Example

Unit mm
Surface Data

| Surface Number | r | d | nd | νd |
|---|---|---|---|---|
| 1 | ∞ | 0.70 | 1.51000 | 60.0 |
| 2 | ∞ | (variable) | | |
| 3* | 136.125 | 8.69 | 1.69350 | 53.2 |
| 4* | −43.222 | 8.67 | | |
| 5* | −28.738 | 3.00 | 1.63550 | 23.8 |
| 6* | −89.027 | 0.30 | | |
| 7* | −231.429 | 5.74 | 1.53110 | 55.9 |
| 8* | −46.578 | 2.68 | | |
| 9* | −39.537 | 2.66 | 1.63550 | 23.8 |
| 10* | −55.894 | 1.84 | | |
| 11* | −2299.162 | 5.94 | 1.53110 | 55.9 |
| 12* | −60.213 | 1.20 | | |
| 13 | 110.718 | 4.00 | 1.55332 | 71.7 |
| 14 | −332.326 | 27.00 | | |
| 15 (eye point) | | | | |

Aspheric Surface Data

3rd surface

| | | |
|---|---|---|
| K = −6.07439e+000 | A 4 = −1.82896e−006 | A 6 = −5.07089e−009 |

4th surface

| | | |
|---|---|---|
| K = 5.99930e−001 | A 4 = 1.41427e−006 | A 6 = 4.25770e−010 |

5th surface

| | | |
|---|---|---|
| K = 1.13826e−001 | A 4 = −6.11987e−007 | A 6 = 2.58066e−008 |

6th surface

| | | |
|---|---|---|
| K = −7.86704e+000 | A 4 = 6.27492e−007 | A 6 = −5.81898e−010 |

7th surface

| | | |
|---|---|---|
| K = −3.07481e+001 | A 4 = −8.80513e−007 | A 6 = −3.57889e−009 |

8th surface

| | | |
|---|---|---|
| K = 5.53963e−001 | A 4 = −2.76657e−006 | A 6 = 4.45282e−009 |

9th surface

| | | |
|---|---|---|
| K = −1.40844e−001 | A 4 = 1.47140e−006 | A 6 = −7.32877e−009 |

10th surface

| | | |
|---|---|---|
| K = 3.06010e+000 | A 4 = 6.99258e−007 | A 6 = 1.21727e−009 |

11th surface

| | | |
|---|---|---|
| K = 1.00225e+004 | A 4 = −2.66396e−007 | A 6 = 8.58565e−011 |
| A 8 = 9.72106e−013 | | |

12th surface

| | | |
|---|---|---|
| K = −3.51427e−001 | A 4 = 2.36708e−007 | A 6 = 2.33340e−010 |
| A 8 = −4.05287e−013 | | |

Various Data

| | | | |
|---|---|---|---|
| Diopter [diopter] | −2.0 | +2.0 | −4.0 |
| Focal Length | 45.99 | 45.99 | 45.99 |
| d 2 | 19.29 | 27.62 | 15.12 |

### Seventh Numerical Example

Unit mm
Surface Data

| Surface Number | r | d | nd | νd |
|---|---|---|---|---|
| 1 | ∞ | 0.70 | 1.51000 | 60.0 |
| 2 | ∞ | (variable) | | |
| 3 | −65.913 | 3.14 | 2.00069 | 25.5 |
| 4 | −48.248 | 10.11 | | |
| 5 | −34.250 | 3.19 | 1.76182 | 26.5 |
| 6 | −1000.301 | 1.69 | | |
| 7* | −4010.368 | 6.95 | 1.58313 | 59.4 |
| 8* | −44.146 | 1.21 | | |
| 9* | 161.388 | 5.20 | 1.63550 | 23.8 |
| 10* | 44.387 | 1.20 | | |
| 11 | 64.814 | 8.88 | 1.83481 | 42.7 |
| 12 | −64.313 | 27.00 | | |
| 13 (eye point) | | | | |

Aspheric Surface Data

7th surface

| | | |
|---|---|---|
| K = 1.33592e+004 | A 4 = −7.84416e−006 | A 6 = 7.50739e−009 |

8th surface

| | | |
|---|---|---|
| K = −6.98689e−001 | A 4 = 3.30466e−006 | A 6 = −8.53288e−009 |

9th surface

| | | |
|---|---|---|
| K = −2.65944e+002 | A 4 = −3.33664e−006 | A 6 = −9.10796e−009 |

10th surface

| | | |
|---|---|---|
| K = −9.09514e+000 | A 4 = −5.30646e−006 | A 6 = 3.91499e−009 |

Various Data

| | | | |
|---|---|---|---|
| Diopter [diopter] | −2.0 | +0.7 | −3.3 |
| Focal Length | 61.32 | 61.32 | 61.32 |
| d 2 | 21.46 | 31.12 | 17.55 |

TABLE 1

| | First | Second | Third | Fourth | Fifth | Sixth |
|---|---|---|---|---|---|---|
| | Exemplary | Exemplary | Exemplary | Exemplary | Exemplary | Exemplary |
| | Embodiment | Embodiment | Embodiment | Embodiment | Embodiment | Embodiment |
| Conditional | 1.24 | 1.24 | 1.19 | 1.01 | 1.24 | 1.24 |
| expression (1) | (G2, G4) | (G2, G4) | (G3, G4) | (G1, G3, G5) | (G2, G4) | (G2, G4) |
| | 1.01 | 1.19 | | 1.24 | 1.01 | 1.01 |
| | (G3) | (G3) | | (G2, G4) | (G3) | (G3, G5) |
| Conditional | 0.48 | 0.43 | 0.60 | 0.89 | 0.41 | 0.58 |
| expression (2) | | | | | | |
| Conditional | 1.71 | 1.71 | 1.68 | 1.72 | 1.71 | 1.71 |
| expression (3) | (G2, G4) | (G2, G4) | (G3, G4) | (G1, G3, G5) | (G2, G4) | (G2, G4) |
| | 1.72 | 1.68 | | 1.71 | 1.72 | 1.72 |
| | (G3) | (G3) | | (G2, G4) | (G3) | (G3, G5) |
| Conditional | −1.44 | −1.03 | 0.78 | 0.97 | −0.61 | −0.68 |
| expression (4) | (G2) | (G2) | (G2) | (G1) | (G2) | (G2) |
| | 0.97 | 0.51 | 0.75 | −0.78 | 0.23 | 0.42 |
| | (G3) | (G3) | (G4) | (G2) | (G3) | (G3) |
| | −0.67 | −0.51 | | 0.38 | −0.089 | −0.20 |
| | (G4) | (G4) | | (G3) | (G4) | (G4) |
| | | | | −0.20 | | 0.40 |
| | | | | (G4) | | (G5) |
| | | | | 0.44 | | |
| | | | | (G5) | | |
| Conditional | 23.8 | 23.8 | — | 23.8 | 23.8 | 23.8 |
| expression (5) | | | | | | |
| Conditional | −12.0 × 10⁻⁵ | −12.0 × 10⁻⁵ | −13.0 × 10⁻⁵ | −11.0 × 10⁻⁵ | −12.0 × 10⁻⁵ | −12.0 × 10⁻⁵ |
| expression (6) | (G2, G4) | (G2, G4) | (G3, G4) | (G1, G3, G5) | (G2, G4) | (G2, G4) |
| | −11.0 × 10⁻⁵ | −13.0 × 10⁻⁵ | | −12.0 × 10⁻⁵ | −11.0 × 10⁻⁵ | −11.0 × 10⁻⁵ |
| | (G3) | (G3) | | (G2, G4) | (G2, G4) | (G3, G5) |
| | | | | | −11.0 × 10⁻⁵ | |
| | | | | | (G3) | |
| Conditional | 1.835 | 1.806 | 1.699 | 1.497 | 1.516 | 1.553 |
| expression (7) | | | | | | |
| Conditional | 2.09 | 2.55 | 5.68 | 2.22 | 2.30 | 2.20 |
| expression (8) | | | | | | |
| Conditional | 0.64 | 0.83 | 0.64 | 0.73 | 0.73 | 0.83 |
| expression (9) | | | | | | |

TABLE 2

| | First | Second | Fifth | Sixth | Seventh |
|---|---|---|---|---|---|
| | Exemplary | Exemplary | Exemplary | Exemplary | Exemplary |
| | Embodi- | Embodi- | Embodi- | Embodi- | Embodi- |
| | ment | ment | ment | ment | ment |
| Conditional | 23.8 | 23.8 | 23.8 | 23.8 | 23.8 |
| expression | 23.8 | 23.8 | 23.8 | 23.8 | |
| (10) | | | | | |
| Conditional | −0.69 | −0.97 | −1.65 | −1.48 | −1.60 |
| expression | −1.49 | −1.96 | −11.27 | −4.93 | |
| (11) | | | | | |
| Conditional | 0.77 | 1.28 | 2.35 | 1.95 | 1.76 |
| expression | 1.42 | 2.03 | 11.24 | 5.83 | |
| (12) | | | | | |
| Conditional | 0.835 | 1.806 | 1.516 | 1.553 | 1.835 |
| expression | | | | | |
| (13) | | | | | |
| Conditional | 0.64 | 0.83 | 0.73 | 0.83 | 0.83 |
| expression | | | | | |
| (14) | | | | | |

Next, an exemplary embodiment of a video camera using an eyepiece lens as described in each of the exemplary embodiments will be described with reference to FIG. 15.

FIG. 15 illustrates a video camera main body 10, an image pickup optical system 11 that forms an object image on an image pickup device (not illustrated), and a sound collecting microphone 12. An observation device (electronic viewfinder) 13 used to observe the object image displayed on an image display device (not illustrated) through the eyepiece lens according to an exemplary embodiment of the present disclosure. The image display device includes a liquid crystal panel or the like, and the object image formed by the image pickup optical system 11 and the like are displayed on the image display device.

While the present inventions have been described with reference to exemplary embodiments, it is to be understood that the inventions are not limited to the disclosed exemplary embodiments. The scope of the following claims is to be accorded the broadest interpretation so as to encompass all such modifications and equivalent structures and functions.

This application claims the benefit of Japanese Patent Application No. 2014-176292, filed Aug. 29, 2014, and Japanese Patent Application No. 2014-176296, filed Aug. 29, 2014, which applications are hereby incorporated by reference herein in their entireties.

What is claimed is:

1. An eyepiece lens comprising:
five or more lenses, including two or more resin lenses each having a lens surface of an aspheric shape, wherein material of a lens Le arranged closest to an observation side of the eyepiece lens is glass material, and material of all of the two or more resin lenses included in the eyepiece lens satisfies a following conditional expression:
0.5<Rdens<1.5,
where a specific gravity of the material of all of the two or more resin lenses is Rdens.

2. The eyepiece lens according to claim 1, wherein two or more lenses of the five or more lenses have a negative refractive power.

3. The eyepiece lens according to claim 1, wherein a following conditional expression is satisfied:
0.25<dr/D<0.95,
where a total sum of thicknesses on an optical axis of all of the lenses included in the eyepiece lens is D, and a total sum of thicknesses on the optical axis of all of the two or more resin lenses included in the eyepiece lens is dr.

4. The eyepiece lens according to claim 1, wherein the material of all of the two or more resin lenses included in the eyepiece lens satisfies a following conditional expression:
1.55<ndr+0.0033×νdr<1.80,
where a refractive index of the material of the two or more resin lenses included in the eyepiece lens for a d line is ndr, and an Abbe number of the material of all of the two or more resin lenses is νdr.

5. The eyepiece lens according to claim 1, wherein all of the two or more resin lenses included in the eyepiece lens satisfy a following conditional expression:
−2.5<f/fr<2.0,
where a focal length of each of the two or more resin lenses included in the eyepiece lens is fr, and a focal length of the eyepiece lens is f.

6. The eyepiece lens according to claim 1, wherein at least one resin lens having a positive refractive power is included in the two or more resin lenses, and at least one resin lens having a negative refractive power is included in the two or more resin lenses.

7. The eyepiece lens according to claim 1, wherein a resin lens having a negative refractive power is included in the two or more resin lenses, and a following conditional expression is satisfied:
5.0<νdrn<35.0,
where an Abbe number of the material of the resin lens having the negative refractive power for a d line is νdrn.

8. The eyepiece lens according to claim 1, wherein the material of all of the two or more resin lenses included in the eyepiece lens satisfies a following conditional expression:
−50.0×10⁻⁵/° C.<dnr/dT<−5.0×10⁻⁵/° C.,
where a temperature coefficient of a refractive index of the material of the two or more resin lenses included in the eyepiece lens for a d line is dnr/dT.

9. The eyepiece lens according to claim 1, wherein a following conditional expression is satisfied:
1.450<ndE<2.100,
where a refractive index of the material of the lens Le for a d line is ndE.

10. The eyepiece lens according to claim 1, wherein a following conditional expression is satisfied:
1.60<fe2/D<12.00,
where a composite focal length of the lens Le and a lens arranged adjacent to an object side of the lens Le is fe2, and a total sum of thicknesses on an optical axis of all of the lenses included in the eyepiece lens is D.

11. The eyepiece lens according to claim 1, wherein the five or more lenses of the eyepiece lens consist of, in order from an object side to the observation side, a first lens having a positive refractive power, a second lens having a negative refractive power, a third lens having a positive refractive power, a fourth lens having a negative refractive power, and a fifth lens having a positive refractive power.

12. The eyepiece lens according to claim 1, wherein the five or more lenses of the eyepiece lens consist of, in order from an object side to the observation side, a first lens having a positive refractive power, a second lens having a negative refractive power, a third lens having a positive refractive power, a fourth lens having a negative refractive power, a fifth lens having a positive refractive power, and a sixth lens having a positive refractive power.

13. The eyepiece lens according to claim 1, wherein the five or more lenses of the eyepiece lens consist of, in order from an object side to the observation side, a first lens having a negative refractive power, a second lens having a positive refractive power, a third lens having a positive refractive power, a fourth lens having a positive refractive power, and a fifth lens having a negative refractive power.

14. The eyepiece lens according to claim 1, wherein all of the lenses that constitute the eyepiece lens are integrally moved in diopter adjustment.

15. An observation device comprising:
an image display device configured to display an image; and
an eyepiece lens including five or more lenses, including two or more resin lenses each having a lens surface of an aspheric shape, the eyepiece lens for observing the image displayed on an image display surface of the image display device,
wherein material of a lens Le arranged closest to an observation side of the eyepiece lens is glass material, and
material of all of the two or more resin lenses included in the eyepiece lens satisfies a following conditional expression:
0.5<Rdens<1.5,
where a specific gravity of the material of the two or more resin lenses is Rdens, and
wherein the eyepiece lens satisfies a following conditional expression:
0.50<H/f<1.20,
where a focal length of the eyepiece lens is f, and a diagonal length of the image display surface is H.

16. An imaging apparatus comprising:
an image pickup device;
an image pickup optical system configured to form an object image on the image pickup device;
an image display device configured to display the object image; and
an eyepiece lens including five or more lenses, including two or more resin lenses each having a lens surface of an aspheric shape, the eyepiece lens used for observing the object image displayed on the image display device,
wherein material of all of the two or more resin lenses included in the eyepiece lens satisfies a following conditional expression:
0.5<Rdens<1.5,
where a specific gravity of the material of the two or more resin lenses is Rdens.

17. An eyepiece lens comprising:
five or more lenses,
wherein a following conditional expression is satisfied:
5.0<νd<30.0,
where an Abbe number of material of the five or more lenses for a d line is νd,
wherein a resin lens R having a lens surface of an aspheric shape is included in the five or more lenses, and
wherein lenses made of glass material are respectively arranged at an object side and at an observation side of the resin lens R.

18. The eyepiece lens according to claim 17, wherein two or more lenses having a positive refractive power and two or more lenses having a negative refractive power are included in the five or more lenses.

19. The eyepiece lens according to claim 17, wherein the resin lens R included in the eyepiece lens satisfies a following conditional expression:
−15.00<fR/f<0.00,
where a focal length of the resin lens R is fR, and a focal length of the eyepiece lens is f.

20. The eyepiece lens according to claim 17, wherein the resin lens R included in the eyepiece lens satisfies a following conditional expression:
0.30<|R1+R2|/|R1−R2|<20.00,
where a curvature radius of a lens surface at an object side of the resin lens R is R1, and a curvature radius of a lens surface at an observation side of the resin lens R is R2.

21. The eyepiece lens according to claim 17, wherein a following conditional expression is satisfied:
1.450<ndE<2.100,
where a refractive index of the material of the lens arranged closest to the observation side in the eyepiece lens for a d line is ndE.

22. The eyepiece lens according to claim 17, wherein the material of the resin lens R is a thermoplastic resin.

23. The eyepiece lens according to claim 17, wherein the five or more lenses of the eyepiece lens consist of, in order from an object side of the eyepiece lens to an observation side of the eyepiece lens, a first lens having a positive refractive power, a second lens having a negative refractive power, a third lens having a positive refractive power, a fourth lens having a negative refractive power, and a fifth lens having a positive refractive power.

24. The eyepiece lens according to claim 17, wherein the five or more lenses of the eyepiece lens consist of, in order from an object side of the eyepiece lens to an observation side of the eyepiece lens, a first lens having a positive refractive power, a second lens having a negative refractive power, a third lens having a positive refractive power, a fourth lens having a negative refractive power, a fifth lens having a positive refractive power, and a sixth lens having a positive refractive power.

25. The eyepiece lens according to claim 17, wherein all of the lenses that constitute the eyepiece lens are integrally moved in diopter adjustment.

26. An observation device comprising:
an image display device configured to display an image; and
an eyepiece lens including five or more lenses, the eyepiece lens used for observing the image displayed on an image display surface of the image display device,
wherein the eyepiece lens satisfies a following conditional expression:
5.0<νd<30.0,
where an Abbe number of material of the five or more lenses for a d line is νd,
wherein a resin lens R having a lens surface of an aspheric shape is included in the five or more lenses,
wherein lenses made of glass material are respectively arranged at an object side and at an observation side of the resin lens R, and
wherein a following conditional expression is satisfied:
0.52<H/f<0.91,
where a diagonal length of the image display surface is H, and a focal length of the eyepiece lens is f.

27. An imaging apparatus comprising:
an image pickup device;
an image pickup optical system configured to form an object image on the image pickup device;
an image display device configured to display the object image; and
an eyepiece lens including five or more lenses, the eyepiece lens used for observing the object image displayed on the image display device,
wherein the eyepiece lens satisfies a following conditional expression:
5.0<νd<30.0,
where an Abbe number of material of the five or more lenses for a d line is νd,
wherein a resin lens R having a lens surface of an aspheric shape is included in the five or more lenses, and
wherein lenses made of glass material are respectively arranged at an object side and at an observation side of the resin lens R.
